(19) United States
(12) Patent Application Publication
(10) Pub. No.: US 2024/0031234 A1
(43) Pub. Date: Jan. 25, 2024

(54) WIRELESS CONNECTIONS FOR EDGE VIRTUALIZATION MANAGEMENT

(71) Applicant: VMware, Inc., Palo Alto, CA (US)

(72) Inventors: Tiejun Chen, Beijing (CN); Olivier Alain Cremel, Los Altos, CA (US)

(21) Appl. No.: 17/886,893

(22) Filed: Aug. 12, 2022

(30) Foreign Application Priority Data
Jul. 19, 2022 (WO) PCT/CN2022/106456

(51) Int. Cl. H04L 41/0895; H04L 61/5014; G06F 9/455

(52) U.S. Cl. CPC H04L 41/0895; H04L 61/5014; G06F 9/45558; G06F 2009/45595; G06F 2009/45579

(57) ABSTRACT

Aspects of wireless communications for edge virtualization management are described. An edge hypervisor launches a wireless communications virtual machine (VM) that includes a guest operating system (OS). The guest OS provides drivers for a wireless adapter of the edge device. A component of the wireless communications VM configures network connection data that enables a wireless adapter to connect to a wireless network. The wireless communications VM executes a Dynamic Host Configuration Protocol (DHCP) component. A wireless network connection is enabled using the edge hypervisor and the wireless communications virtual machine. The DHCP component identifies IP data for the wireless network connection.

### CROSS REFERENCE TO RELATED APPLICATIONS

This application is a § 111(a) application claiming priority to and benefit of PCT Application No. PCT/CN2022/106456, filed on Jul. 19, 2022 and entitled WIRELESS CONNECTIONS FOR EDGE VIRTUALIZATION MANAGEMENT, the contents of which is hereby incorporated herein by reference in its entirety.

### BACKGROUND

Cloud computing systems can extend the capabilities of an organization's data center using computing resources such as virtual machines. A virtualized computing environment can include various host devices that are executing virtual machines that perform various tasks for an enterprise. The virtualized computing environment can support a virtual desktop infrastructure, server infrastructure, user authentication services, security systems, or other computing needs and tasks that might be required by an enterprise. The virtualized computing environment can be managed by a virtualization management system that can manage a virtual infrastructure across a public, private, or hybrid cloud environment. The virtualization management system can also orchestrate containerized execution environments that allow an enterprise to deploy or publish applications, network functions, and other functionalities for its users.

As the workplace environment develops, work locations can change from a single office location, to multiple locations. A modern workplace can include locations that can lack traditional networking backbones or other networking facilities. However, building out traditional networks can be prohibitively expensive whether the location is in a rural or urban environment. As a result, there is a need to develop the ability for virtualization systems to utilize additional networking options.

### BRIEF DESCRIPTION OF THE DRAWINGS

FIG. 1 is an example of a block diagram of a networked environment including a virtualization computing environment according to various examples of the disclosure.

FIG. 2 is a drawing that shows an example of functionalities performed by components of the networked environment that enable wireless communications for edge virtualization management according to various examples of the disclosure.

FIG. 3 is a drawing illustrating example functionalities performed by components of the networked environment that enable wireless communications for edge virtualization management according to various examples of the disclosure.

FIG. 4 is a flowchart illustrating additional example functionalities performed by components of the networked environment that enable wireless communications for edge virtualization management according to various examples of the disclosure.

### DETAILED DESCRIPTION

The present disclosure relates to enabling wireless communications for edge virtualization management. A modern workplace can include locations that can lack traditional networking backbones or other networking facilities. However, building out traditional networks can be prohibitively expensive whether the location is in a rural or urban environment. As a result, there is a need to develop the ability for virtualization systems to utilize additional networking options at the edge. Running virtualization at the edge can help with costs, time to market, security, multi-tenancy, flexibility and interoperability, and software-defined architecture. However, implementation of virtualization at the edge can include problems and challenges including resource constraints, time requirements, and security issues. One way to allay the infrastructure costs of networking at the edge is to utilize wireless communication technologies. However, it can be difficult to develop and maintain the necessary wireless communication device drivers and protocols specifically for a hypervisor. The mechanisms described herein enable wireless communications with edge hypervisors for virtualization commands. The mechanisms can provide for updated wireless communication device drivers and protocols as well as Dynamic Host Configuration Protocol (DHCP) service access using a virtual machine (VM) executed by an edge hypervisor. This edge VM can enable network communications including communications with a virtualization service. The virtualization service can manage the edge hypervisor through the wireless communications passthrough provided using the VM.

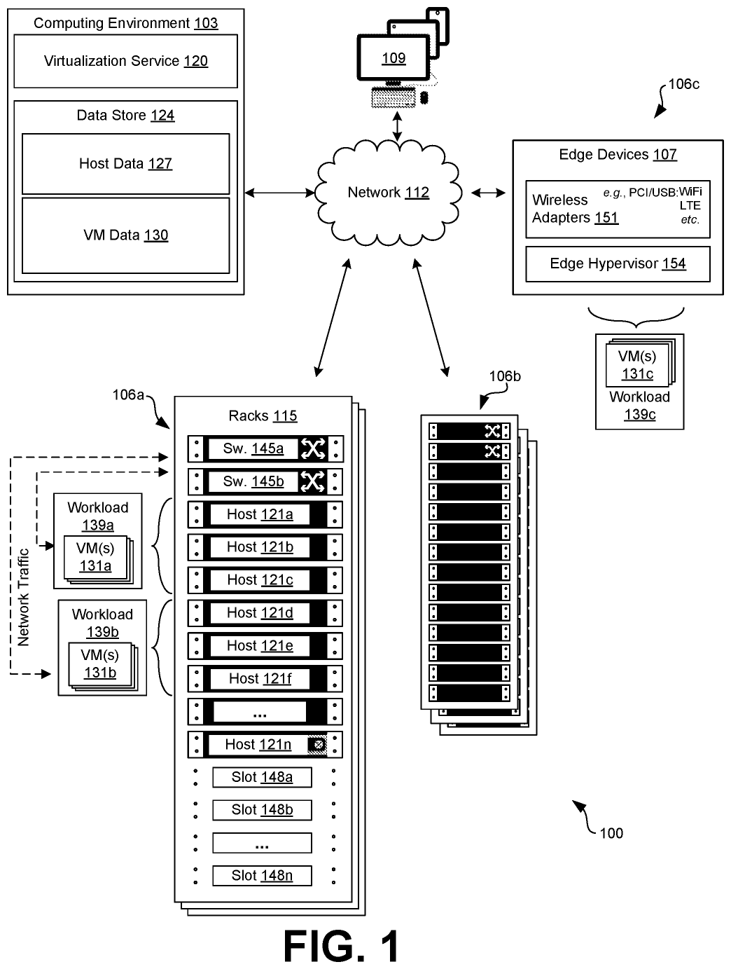

FIG. 1 shows an example of a networked environment 100. The networked environment 100 can include a computing environment 103, various computing clusters 106 (e.g., 106a, 106b), one or more edge devices 107, and one or more client devices 109 in communication with one another over a network 112. The network 112 can include wide area networks (WANs) and local area networks (LANs). These networks can include wired or wireless components, or a combination thereof. Wired networks can include Ethernet networks, cable networks, fiber optic networks, and telephone networks such as dial-up, digital subscriber line (DSL), and integrated services digital network (ISDN) networks. Wireless networks can include cellular networks, satellite networks, Institute of Electrical and Electronic Engineers (IEEE) 802.11 wireless networks (i.e., WI-FI®), BLUETOOTH® networks, microwave transmission networks, Long Term Evolution (LTE) networks, as well as other networks relying on radio broadcasts. The network 112 can also include a combination of two or more networks 112. Examples of networks 112 can include the Internet, intranets, extranets, virtual private networks (VPNs), and similar networks. As the networked environment 100 can serve up virtual desktops to end users, the networked environment 100 can also be described as a virtual desktop infrastructure (VDI) environment.

In some examples, the computing environment 103 can include an enterprise computing environment that includes hundreds or even thousands of physical machines, VMs, and other software implemented in devices stored in racks 115, distributed geographically across locations or sites that include computing clusters 106 (e.g., computing clusters 106a, 106b, 106c) and connected to one another through the network 112. It is understood that any VM or virtual appliance is implemented using at least one physical device.

The computing environment 103 can include, for example, a server or any other system providing computing capability. Alternatively, the computing environment 103 can include one or more computing devices that are arranged, for example, in one or more server banks, computer banks, computing clusters, or other arrangements. The computing environment 103 can include a grid computing resource or any other distributed computing arrangement. The computing devices can be located in a single installation or can be distributed among many different geographical locations.

Although shown separately from the computing clusters 106, in some examples, one or more of the computing clusters 106 can be a portion of the computing environment 103. Generally, the computing clusters 106 that are a portion of the computing environment 103 are those that are Internet Protocol (IP) accessible to the virtualization service 120 and all of the hosts 121 of the computing environment 103.

Various applications can be executed on the computing environment 103. For example, a virtualization service 120 can be executed by the computing environment 103. Other applications, services, processes, systems, engines, or functionality not discussed in detail herein may also be executed or implemented by the computing environment 103.

The computing environment 103 can include or be operated as one or more virtualized computer instances. For purposes of convenience, the computing environment 103 is referred to herein in the singular. Even though the computing environment 103 is referred to in the singular, it is understood that a plurality of computing environments 103 can be employed in the various arrangements as described above. As the computing environment 103 communicates with the computing clusters 106 and client devices 109 for end users over the network 112, sometimes remotely, the computing environment 103 can be described as a remote computing environment 103 in some examples. Additionally, in some examples, the computing environment 103 can be implemented in hosts 121 (e.g., 121a . . . 121n) of a rack 115 and can manage operations of the virtualized computing environment 103. Hence, in some examples, the computing environment 103 can be referred to as a management cluster in the computing clusters 106.

The computing environment 103 can include a data store 124. The data store 124 can include memory of the computing environment 103, mass storage resources of the computing environment 103, or any other storage resources on which data can be stored by the computing environment 103. The data store 124 can include memory of the hosts 121 in some examples. In some examples, the data store 124 can include one or more relational databases, object-oriented databases, hierarchical databases, hash tables or similar key-value data stores, as well as other data storage applications or data structures. The data stored in the data store 124, for example, can be associated with the operation of the various services or functional entities described below. For example, host data 127, VM data 130, and/or other data can be stored in the data store 124.

In various embodiments, the virtualization service 120 can include a computer program that resides and executes in a central server, which may reside in the computing environment 103, and can run in a VM 131 (e.g., 131a . . . 131c) in one of hosts 121 or edge devices 107. One example of a virtualization management module or virtualization service is the vCenter Server® product made available from VMware, Inc. The virtualization service 120 is configured to carry out administrative tasks for a virtualized environment, including managing hosts 121, managing workloads 139 (e.g., 139a . . . 139f), managing VMs 131 running within each host 121, provisioning VMs 131, migrating VMs 131 from one host 121 to another host 121, and load balancing between the hosts 121. In one embodiment, the virtualization service 120 can manage and integrate virtual computing resources provided by a third party cloud computing system with virtual computing resources of virtualization service 120 to form a unified “hybrid” computing platform.

The virtualization service 120 includes a resource management service and/or other applications. The resource management service can be executed to allocate workloads 139 (e.g., 139a . . . 139f) to one or more hosts 121 based on various factors. For example, the resource management service can add an extra host 121 to the set of hosts 121 assigned to a workload 139 in response to an increase in demand for computing resources. As another example, the resource management service can reassign workloads 139 or VMs 131 within a workload 139 from one host 121 to another host 121 in order to more effectively use the hosts 121 assigned to the workload 139.

For example, if a first host 121 is scheduled for an upgrade, the resource management service can reassign the VMs 131 executing on the first host 121 to a second host 121 based on various factors that can be used to identify the second host 121 as the best candidate host 121 among other hosts 121 in the data center. The resource management service can include a number of modules and components that work in concert for management of the hosts 121 and workloads 139. For example, the resource management service can include VSphere™ High Availability (HA), VMware Distributed Resource Scheduler (DRS), VMware VCenter™ Server, and other VMware VSphere™ components. The various components of the resource management service can work in concert to achieve the functionalities described for the resource management service.

The host data 127 can contain information about the hosts 121 that are managed by the virtualization service 120. For example, the host data 127 can include information such as the amount of memory installed on the host 121, the number and type of processors installed on the host 121, the number and type of GPUs installed on the host 121, the number and type of network connections installed on the host 121, and various other data. The host data 127 can also include a record of the workload(s) 139 (e.g., specific VMs 131) performed by particular host(s) 121.

VM data 130 represents information about the VMs 131 that are executed by the hosts 121 within the virtualized computing environment 103. VM data 130 can include allocated CPU, memory, and storage resources for the various VMs, network configuration for the VMs, or an operating system (OS) image for the VMs. VM data 130 can also include certificate data, encryption data, security credentials, or other data needed to configure and operate the VMs 131 within the virtualized computing environment 103.

In various embodiments, the computing clusters 106 can include a plurality of devices installed in racks 115, which can make up a server bank, aggregate computing system, or a computer bank in a data center or another like facility. In some examples, the computing cluster can include a high-availability computing cluster. A high-availability computing cluster can include a group of computing devices that act as a single system and provides a continuous uptime for workloads. The devices in the computing clusters 106 can include any number of physical machines that perform workloads that include, VMs, virtual appliances, OSs, drivers, hypervisors, scripts, and applications.

The devices in the racks 115 can include, for example, memory and storage devices, hosts 121a . . . 121n, switches 145a . . . 145b, and other devices. Hosts 121 can include graphics cards having one or more graphics processing units (GPUs) installed thereon, central processing units (CPUs), power supplies, and other components. The devices, such as hosts 121 and switches 145, can have dimensions suitable for quick installation in slots 148a . . . 148n on the racks 115. In various examples, the hosts 121 can include requisite physical hardware and software to create and manage a virtualization infrastructure. The physical hardware for a host 121 can include a CPU, graphics card (having one or more GPUs), data bus, memory, and other components. In some examples, the hosts 121 can include a pre-configured hyper-converged computing device where a hyper-converged computing device includes pre-tested, pre-configured, and pre-integrated storage, server and network components, including software, that are positioned in an enclosure installed in a slot 148 on a rack 115.

The various physical and virtual components of the computing clusters 106 can process workloads 139. Workloads 139 can represent individual VMs 131 and sets of VMs 131 executed on the hosts 121. The VMs 131 can embody or include various applications that are executed for an organization or enterprise. The VMs 131 can provide functionalities including applications, data, and network functions to the client devices 109.

In addition to a VM 131, a workload 139 can correspond to other components running on the host 121. These can include one or more containers of Kubernetes® pods, one or more vSAN® components, one or more data transport connections, one or more network functions, and other components. The various components can provide functionalities that can be accessed by various client devices 109 for enterprise purposes.

Workloads 139 can be executed on a host 121 that runs a hypervisor that facilitates access to the physical resources of the host device by the workloads 139 running atop the hypervisor. In some examples, the hypervisor can be installed on a host 121 or an edge device 107 to support a VM execution space wherein one or more VMs can be concurrently instantiated and executed. In some examples, the hypervisor can include the VMware ESX™ hypervisor, the VMware ESXi™ hypervisor, or similar hypervisor.

A hardware computer device such as a host 121 can execute an instance of one or more VMs 131. Each host 121 that acts as a host in the networked environment 100, and thereby includes one or more VMs 131, can also include a hypervisor. In some examples, the hypervisor can be installed on a host 121 to support a VM execution space wherein one or more VMs 131 can be concurrently instantiated and executed. In some examples, the hypervisor can include the VMware ESX™ hypervisor, the VMware ESXi™ hypervisor, or similar hypervisor. It is understood that the computing clusters 106 are scalable, meaning that the computing clusters 106 in the networked environment 100 can be scaled dynamically to include additional hosts 121, switches 145, power sources, and other components, without degrading performance of the virtualization environment. Further, various physical and virtual components of the computing clusters 106 can process workloads 139. Workloads 139 can refer to the amount of processing that a host 121, switch 145, GPU, or another physical or virtual component has been instructed to process or route at a given time. The workloads 139 can be associated with VMs 131 or other software executing on the hosts 121.

An edge device 107 can include a host 121 executed outside of the computing environment 103. The edge device 107 can include a networking interface card (NIC), a networking DPU device or smart NIC, a switch 145, a router, a gateway device, or another networking device that provides network functions using its physical hardware. The edge device 107 can also provide virtual network functions. The edge device 107 can also include a hardware computer device such as a server executed at the edge rather than in a larger or centralized cluster. The edge device 107 can be a computing device that provides and/or is part of a private network. In some examples, the edge device 107 can include a traditional wired connection to the private network as well as to a public wide area network such as the Internet. The edge device 107 can communicate with the virtualization service 120 using the public wide area network. In some examples, the edge device 107 can lack a traditional wired connection.

An edge device 107 can include an edge hypervisor 154 that provides virtualization services by launching and managing edge-located VMs 131c and workloads 139c. The edge device 107 can include hardware resources that include various wireless adapters 151. The wireless adapters 151 can include devices that are connected to the edge device using a PCI, PCIe, USB, or another type of bus connection. The wireless adapters 151 can include a WiFi adapter, an LTE adapter, and other types of wireless adapters.

The edge device 107 can communicate over a public wide area network using one of the wireless adapters 151, while providing private wide or local area network connectivity to the client devices 109 using another one of the wireless adapters 151. The edge hypervisor 154 of the edge device 107 can communicate with the virtualization service 120 using an LTE wireless adapter 151 and receive a command to execute a VM 131c. The edge device 107 can use a WiFi wireless adapter 151 to enable a client device 109 to access enterprise resources provided using the VM 131c. However, in other examples, the edge device 107 can communicate with the virtualization service 120 using a WiFi wireless adapter 151.

The edge hypervisor 154 can include a hypervisor that can perform the functionalities discussed for the hypervisors of the hosts 121. However, the edge hypervisor 154 can include instructions that enable wireless communications that are unsupported by the hypervisors of the hosts 121. The edge hypervisor 154 can be specialized to execute on edge devices such as switches, routers, gateways, or another networking device that provides network functions. The edge hypervisor 154 can include instructions that provide virtual network functions using the edge device 107. The edge hypervisor 165 can also launch edge-specific VMs 131c that enable networking passthrough, access to and provision of DHCP services, and virtual network functions. The edge hypervisor 165 can also launch more generalized VMs 131c that provide access to hardware, software, and data resources to other devices including hosts 121 and client devices 109.

The virtualization service 120 can communicate with the edge device 107 to launch, migrate, and otherwise manage edge workloads 139c including the VMs 131c. This can include launching and executing VMs 131c that cause the edge device 107 to provide virtual network functions in association with the edge device 107 and a client device 109 that communicates with the edge device 107. The virtualization service 120 can communicate with the edge device 107 to execute and manage edge workloads 139 that provide particular data, virtual network functions, applications, and other enterprise resources accessible to client devices 109 that are connected to a same private network as the edge device 107.

The client device 109 can represent a computing device coupled to the network 112. The client device 109 can be a processor-based computer system. According to various examples, the client device 109 can be in the form of a desktop computer, a laptop computer, a personal digital assistant, a mobile phone, a smartphone, or a tablet computer system. The client device 109 can execute an OS, such as Windows™, Android™, or iOS®, and has a network interface to communicate with the network 112.

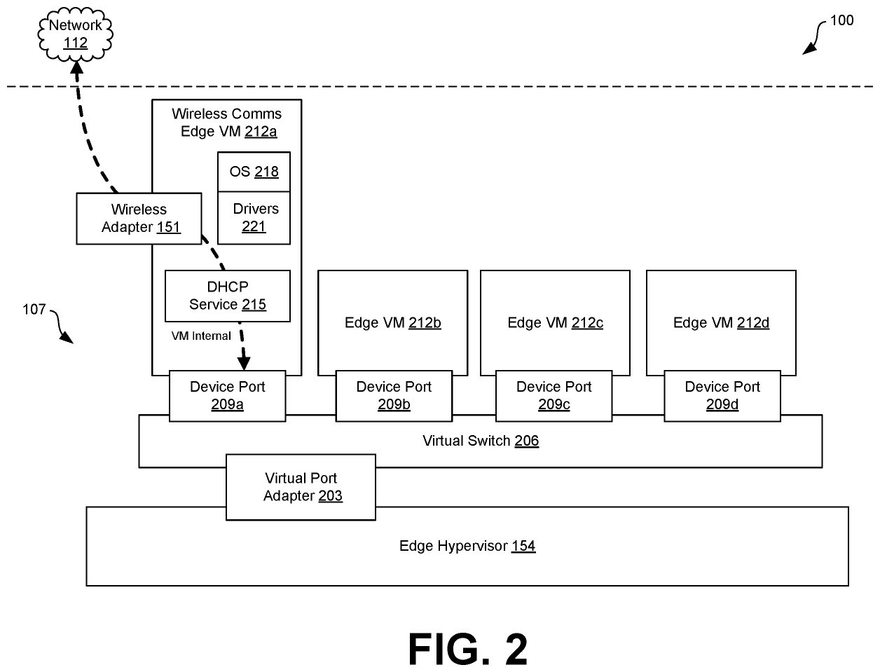

FIG. 2 shows an example of the edge device 107 communicating with a network 112 in the networked environment 100. The figure shows additional detail of how hardware and software components of the edge device 107 can work in concert with the other components of the networked environment 100 to enable wireless communications for edge virtualization management. This can be used for LTE implementations, WiFi implementations, and other situations where a DHCP service 215 internal to the edge device 107 is preferable or an external DHCP service is unavailable.

The edge device 107 includes the wireless adapter 151 and the edge hypervisor 154. The edge hypervisor 154 can generate a virtual port adapter 203 and a virtual switch 206. The virtual port adapter 203 can include a virtualized port that is provided using a kernel of the edge hypervisor 154 in concert with the hardware of the edge device 107. The virtual switch 206 can include a virtualized switch that is provided using a kernel of the edge hypervisor 154 in concert with hardware of the edge device 107.

The edge device 107 includes the physical device ports 209a-209d. The edge hypervisor 154 can configure the physical device ports 209a-209d for various different purposes using different edge VMs 212a-212d corresponding to the device ports 209a-209d. The edge VMs 212a-212d can refer to VMs 131 that include networking-specific functionalities using the device ports 209a-209d. The device ports 209a-209d can refer to networking ports or NIC ports of an NIC, DPU, smart NIC, gateway, router, or another edge device 107.

The virtualization service 120 can include a user interface that enables an administrative user to configure the edge hypervisor 154. The virtualization service 120 can transmit commands to the edge hypervisor 154 that configure the edge device 107 to passthrough a device controller of the wireless adapter 151 to a particular edge VM 212a that enables wireless communications functionalities. This edge VM 212a can be referred to as a wireless communications edge VM 212a. The edge VM 212a and the edge hypervisor 154 can enable a wireless uplink port such as a WiFi or LTE uplink port using the wireless adapter 151.

The edge VM 212a can include DHCP service 215. The DHCP service 215 can be provided internal to the edge VM 212a and the device 107. The DHCP service 215 can automatically provide the edge device 107 with IP data that can include an IP address, subnet mask, and default gateway for the edge device 107. The DHCP service 215 can also lease IP addresses and other IP data for wireless network connections to edge devices 107, hosts 121, client devices 109, the virtualization service 120, and other networking components. The DHCP service 215 can cause the edge device 107 to act as a DCHP server in addition to providing other virtualization services. The DHCP service 215 can be referred to as a DHCP component of the edge VM 212a.

The edge VM 212a can include a guest OS 218 and guest OS drivers 221. The guest OS 218 can include a Linux® OS or another lightweight OS that includes a well developed driver ecosystem. The guest OS drivers 221 can be drivers that are specific to the guest OS 218. The guest OS 218 can include an open-source minimalist Linux OS that is configured to work common container formats, including Docker, Rocket, and Garden containers, among others. In some examples, the edge VM 212a can be a first VM launched by the edge hypervisor 154 or can otherwise have a first or smallest world identifier. The world identifier can refer to identifiers of operational VMs that are executed by the edge device 107, as opposed to VM identifiers that are unique among all VMs managed by the virtualization service 120 for a particular enterprise.

The guest OS 218 can include a package-based lifecycle management system that can be configured using the virtualization service 120. The virtualization service 120 can manage the guest OS 218 by transmitting a command for the edge hypervisor 154 to install a new guest OS 218 package. This can include launching an updated VM, passing control to the new VM, and then shutting down and deleting the previous VM.

The guest OS 218 can identify the wireless adapter 151, as well as install appropriate guest OS drivers 221. The guest OS 218 can identify, retrieve, and install the guest OS drivers 221. The guest OS 218 can identify and install the guest OS drivers 221 based on the identity of the wireless adapter 151. This can enable the edge hypervisor 154 to use the wireless adapter 151 without having its own drivers. The guest OS drivers 221 can be preinstalled such that the guest OS 218 can obtain the guest OS drivers 221 from preinstalled data included in the edge VM 212a, the guest OS 218, or otherwise. In some cases, the guest OS 218 can update or check for updates for the guest OS drivers 221 by transmitting an identity of the wireless adapter 151 to the virtualization service 120, and receiving a command to install the guest OS drivers 221 as identified by the virtualization service 120. The update can be downloaded and installed from a network address specified in the command from the virtualization service 120. The guest OS 218 can then install the guest OS drivers 221 update.

Since the edge device 107 passes through the wireless adapter 151 to the edge VM 212a, the guest OS 218 can provide the guest OS drivers 221 for the wireless adapter 151. This can enable the edge hypervisor 154 to use the wireless adapter 151 even if the edge hypervisor 154 lacks wireless adapter drivers for the wireless adapter 151. The edge VMs 212b-212d can also include instances of the guest OS 218 that are specialized for the purpose and usage of the various device ports 209b-209d.

The edge VM 212a can include an edge connection agent. The edge connection agent can provide networking services including retrieving and applying network connectivity configurations. The network connectivity configurations can include configuring the edge device 107 to connect to a network using an identified WiFi SSID and Password. The network connectivity configurations can include configuring the edge device 107 to connect to a network using an identified LTE provider and account. The edge connection agent can also start/stop/restart/reset the various services. The edge connection agent can reassign and rebind device ports 209a-209d, as well as groups, switches and so on. The edge connection agent can provide a command-line interface (CLI) such as a text-based user interface (UI), and a visual UI to run programs, manage computer files and interact with the computer. The edge connection agent can also include an Application Programming Interface that enables client devices 109 and the virtualization service 120 to remotely manage the functionalities provided by the edge connection agent.

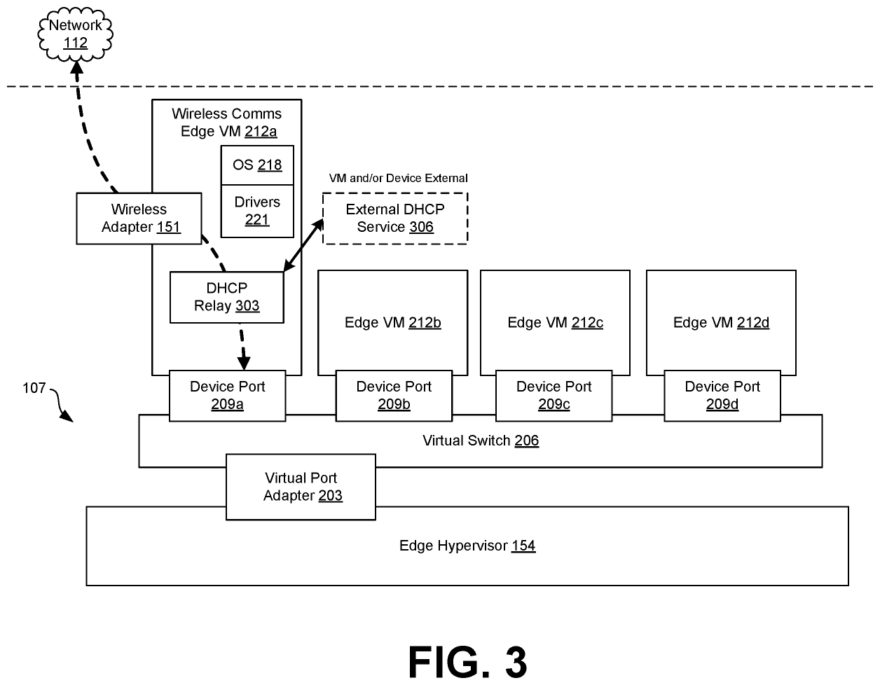

FIG. 3 shows an example of the edge device 107 communicating with a network 112 in the networked environment 100. The figure shows additional detail of how hardware and software components of the edge device 107 can work in concert with the other components of the networked environment 100 to enable wireless communications for edge virtualization management. Generally, the description and discussion of various components in FIG. 2 can apply to the components shown in FIG. 3. However, in this example the edge VM 212a includes a DHCP relay 303 that communicates with an external DHCP service 306. This can be used for WiFi implementations and other implementations where an external DHCP service 306 is preferable. Activating the DHCP service 215 can include making the external DHCP service 306 transparent.

The edge hypervisor 154 can generate a virtual port adapter 203 and a virtual switch 206. The edge device 107 includes the physical device ports 209a-209d. The edge hypervisor 154 can configure the edge device 107 to passthrough a device controller of the wireless adapter 151 to a particular edge VM 212a that enables wireless communications functionalities.

The edge VM 212a can include DHCP relay 303. The DHCP relay 303 can enable the edge VM 212a to relay DHCP requests to external DHCP service 306. In this example, the edge device 107 does not act as a DHCP server, but rather leverages separate external DHCP service 306 that are external to the edge VM 212a and the edge device 107.

The external DHCP service 306 can automatically provide the edge device 107 with an IP address, subnet mask, and default gateway. The external DHCP service 306 can also lease IP addresses and other information to DHCP clients that communicate with the edge device 107, including other edge devices 107, hosts 121, client devices 109, and other networking components. The external DHCP service 306 can be referred to as a DHCP component of the edge VM 212a.

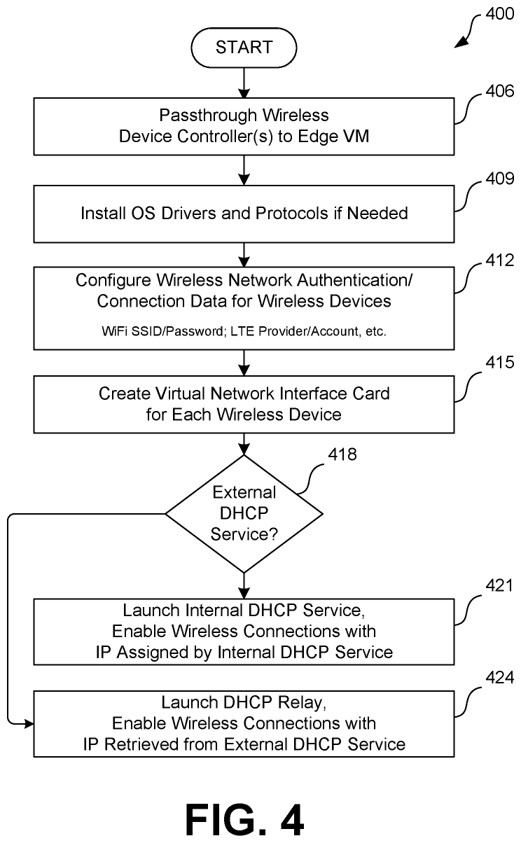

FIG. 4 includes a flowchart 400 that shows functionalities performed by components of the networked environment 100. The flowchart 400 shows how the components of the networked environment 100 work in concert to enable wireless communications for edge virtualization management. While the actions of the steps can be described as performed by a particular device or component, other components of the networked environment 100 can also perform aspects of the steps and actions.

In step 406, the edge device 107 can passthrough a wireless device controller for a wireless adapter 151 to a wireless communications edge VM 212. As part of a startup process or in response to a command from the virtualization service 120, the edge hypervisor 154 can launch the wireless communications edge VM 212.

The edge hypervisor 154 can generate a virtual port adapter 203 and a virtual switch 206. The virtual port adapter 203 can include a virtualized port that is provided using a kernel of the edge hypervisor 154 in concert with hardware of the edge device 107. The virtual switch 206 can include a virtualized switch that is provided using a kernel of the edge hypervisor 154 in concert with hardware of the edge device 107. These and other components can passthrough the wireless device controller for a wireless adapter 151 to the wireless communications edge VM 212. The wireless communications edge VM 212 can include a guest OS 218. The wireless communications edge VM 212 can also include instructions that populate a port of the edge device 107.

In step 409, the edge device 107 can install OS drivers 221. In some examples the guest OS 218 can automatically include a set of common or popular drivers. The guest OS 218 can identify the wireless adapter 151, as well as retrieve and install appropriate guest OS drivers 221. If the guest OS 218 already includes drivers for the wireless adapter 151, then the process can proceed to step 412. However, if the guest OS 218 lacks these drivers, the guest OS 218 can identify, retrieve, and install the guest OS drivers 221.

This can include transmitting an identity of the wireless adapter 151 to the virtualization service 120, and receiving a command to install the guest OS drivers 221 as identified by the virtualization service 120. Alternatively, the guest OS 218 can identify the guest OS drivers 221 based on the identity of the wireless adapter 151 without transmitting a request to the virtualization service 120. The guest OS 218 can download the guest OS drivers 221 from a network address specified in the command virtualization service 120 or stored in data of the guest OS 218. The guest OS 218 can then install the guest OS drivers 221 to enable the edge hypervisor 154 to use the wireless adapter 151 without having its own drivers.

In step 412, the edge device 107 can configure wireless network authentication and connection data for wireless networks to which the edge device 107 will connect. The wireless communications edge VM 212 or the edge hypervisor 154 can include an edge connection agent. The edge connection agent can provide networking services including retrieving and applying network connectivity configurations. The network connectivity configurations can include configuring the edge device 107 to connect to a network using an identified WiFi SSID and Password. The network connectivity configurations can include configuring the edge device 107 to connect to a network using an identified LTE provider and account.

In step 415, the edge device 107 can create a separate virtual network interface card for each wireless adapter 151. The wireless communications edge VM 212 or the edge hypervisor 154 can create a first virtual network interface card for a WiFi wireless adapter 151. The wireless communications edge VM 212 or the edge hypervisor 154 can also create a second virtual network interface card for an LTE wireless adapter 151.

In step 418, the edge device 107 can determine whether to use an external DHCP service 306. This can include checking a setting received from the virtualization service 120 or identifying whether an external DHCP service 306 responds on a particular network. If an external DHCP service 306 fails to respond or is inaccessible, then the process moves to step 421, otherwise the process moves to step 424. Alternatively, the external DHCP service 306 can be used if the wireless adapter 151 is a WiFi adapter, and a VM-based internal DHCP service 215 can be used if the wireless adapter 151 is an LTE adapter.

In step 421, the edge device 107 can launch an internal DHCP service 215 in the wireless communications edge VM 212. The DHCP service 215 can cause the edge device 107 to act as a DHCP server. The edge device 107 can enable wireless communications and connections using IP addresses assigned and leased using the internal DHCP service 215.

In step 424, the edge device 107 can launch a DHCP relay 303 in the wireless communications edge VM 212. The DHCP relay 303 can communicate with a particular external DHCP service 306 external to the wireless communications edge VM 212 and the edge device 107. The edge device 107 can enable wireless communications and connections using IP addresses assigned and leased by the external DHCP service 306.

Functionality attributed to the executable components discussed herein can be implemented in a single process or application or in multiple processes or applications. The separation or segmentation of functionality as discussed herein is presented for illustrative purposes only.

Flowcharts and sequence diagrams can show examples of the functionality and operation of implementations of components described herein. The components described herein can be embodied in hardware, software, or a combination of hardware and software. If embodied in software, each element can represent a module of code or a portion of code that includes program instructions to implement the specified logical function(s). The program instructions can be embodied in the form of, for example, source code that includes human-readable statements written in a programming language or machine code that includes machine instructions recognizable by a suitable execution system, such as a processor in a computer system or other system. If embodied in hardware, each element can represent a circuit or a number of interconnected circuits that implement the specified logical function(s).

Although the flowcharts and sequence diagrams can show a specific order of execution, it is understood that the order of execution can differ from that which is shown. For example, the order of execution of two or more elements can be switched relative to the order shown. Also, two or more elements shown in succession can be executed concurrently or with partial concurrence. Further, in some examples, one or more of the elements shown in the flowcharts can be skipped or omitted.

The computing devices and other hardware components described herein can include at least one processing circuit. Such a processing circuit can include, for example, one or more processors and one or more storage devices that are coupled to a local interface. The local interface can include, for example, a data bus with an accompanying address/control bus or any other suitable bus structure.

The one or more storage devices for a processing circuit can store data or components that are executable by the one or more processors of the processing circuit. For example, the various executable software components can be stored in one or more storage devices and be executable by one or more processors. Also, a data store can be stored in the one or more storage devices.

The functionalities described herein can be embodied in the form of hardware, as software components that are executable by hardware, or as a combination of software and hardware. If embodied as hardware, the components described herein can be implemented as a circuit or state machine that employs any suitable hardware technology. The hardware technology can include, for example, one or more microprocessors, discrete logic circuits having logic gates for implementing various logic functions upon an application of one or more data signals, application specific integrated circuits (ASICs) having appropriate logic gates, programmable logic devices (e.g., field-programmable gate array (FPGAs), and complex programmable logic devices (CPLDs)).

Also, one or more of the components described herein that include software or program instructions can be embodied in any non-transitory computer-readable medium for use by or in connection with an instruction execution system such as a processor in a computer system or other system. The computer-readable medium can contain, store, and/or maintain the software or program instructions for use by or in connection with the instruction execution system.

A computer-readable medium can include a physical media, such as, magnetic, optical, semiconductor, and/or other suitable media. Examples of a suitable computer-readable media include, but are not limited to, solid-state drives, magnetic drives, or flash memory. Further, any logic or component described herein can be implemented and structured in a variety of ways. For example, one or more components described can be implemented as modules or components of a single application. Further, one or more components described herein can be executed in at least one computing device or by using multiple computing devices.

As used herein, “about,” “approximately,” and the like, when used in connection with a numerical variable, can generally refer to the value of the variable and to all values of the variable that are within the experimental error (e.g., within the 95% confidence interval for the mean) or within +/−10% of the indicated value, whichever is greater.

Where a range of values is provided, it is understood that each intervening value and intervening range of values, to the tenth of the unit of the lower limit unless the context clearly dictates otherwise, between the upper and lower limit of that range and any other stated or intervening value in that stated range, is encompassed within the disclosure. The upper and lower limits of these smaller ranges may independently be included in the smaller ranges and are also encompassed within the disclosure, subject to any specifically excluded limit in the stated range. Where the stated range includes one or both of the limits, ranges excluding either or both of those included limits are also included in the disclosure.

It is emphasized that the above-described examples of the present disclosure are merely examples of implementations to set forth for a clear understanding of the principles of the disclosure. Many variations and modifications can be made to the above-described examples without departing substantially from the spirit and principles of the disclosure. All such modifications and variations are intended to be included herein within the scope of this disclosure.

1. A system, comprising:
at least one computing device; and
instructions executable in the at least one computing device that, wherein the instructions, when executed by the at least one computing device, cause the at least one computing device to at least:
launch, by an edge hypervisor of an edge device, a wireless communications virtual machine (VM) comprising a guest operating system (OS) that provides drivers for a wireless adapter of the edge device;
configure, by the wireless communications VM, network connection data that enables a wireless adapter to connect to a wireless network;
execute, within the wireless communications VM, a Dynamic Host Configuration Protocol (DHCP) component that acts as a DHCP server or a DHCP relay for wireless network connections that connect through the edge device, wherein the wireless communications VM comprises the lowest or first operational VM identifier of a set of operational VMs executed by the edge device; and
enable a wireless network connection using the edge hypervisor and the wireless communications VM, wherein the DHCP component of the wireless communications VM assigns or relays Internet Protocol (IP) data for the wireless network connection.

2. The system of claim 1, wherein the edge device passes control of a device controller for the wireless adapter to the wireless communications VM.

3. The system of claim 1, wherein the instructions, when executed by the at least one computing device, cause the at least one computing device to at least:
create a virtual networking interface card (NIC) for a respective one of a plurality of wireless adapters of the edge device, wherein the edge device comprises a physical NIC.

4. The system of claim 1, wherein the instructions, when executed by the at least one computing device, cause the at least one computing device to at least:
identify that the guest OS lacks drivers for the wireless adapter;
retrieve, from a network location, the drivers for the wireless adapter; and
install, to the guest OS, the drivers for the wireless adapter.

5. The system of claim 1, wherein the DHCP component comprises a DHCP service that identifies the IP data by generating and storing the IP data for the wireless network connection.

6. The system of claim 1, wherein the DHCP relay identifies the IP data by retrieving the IP data for the wireless network connection from an external DHCP service external to the wireless communications VM of the edge device.

7. The system of claim 1, wherein the edge device comprises at least one of a gateway device and a router device.

8. A method for upgrade-awareness resource scheduling, comprising:
launching, by an edge hypervisor of an edge device, a wireless communications virtual machine (VM) comprising a guest operating system (OS) that provides drivers for a wireless adapter of the edge device;
configuring, by the wireless communications VM, network connection data that enables a wireless adapter to connect to a wireless network;
executing, within the wireless communications VM, a Dynamic Host Configuration Protocol (DHCP) component that acts as a DHCP server or a DHCP relay for wireless network connections that connect through the edge device, wherein the wireless communications VM comprises the lowest or first operational VM identifier of a set of operational VMs executed by the edge device; and
enabling a wireless network connection using the edge hypervisor and the wireless communications VM, wherein the DHCP component of the wireless communications VM assigns or relays Internet Protocol (IP) data for the wireless network connection.

9. The method of claim 8, wherein the edge device passes control of a device controller for the wireless adapter to the wireless communications VM.

10. The method of claim 8, further comprising:
creating a virtual networking interface card (NIC) for a respective one of a plurality of wireless adapters of the edge device, wherein the edge device comprises a physical NIC.

11. The method of claim 8, further comprising:
identifying that the guest OS lacks the drivers for the wireless adapter;
retrieving, from a network location, the drivers for the wireless adapter; and
installing, to the guest OS, the drivers for the wireless adapter.

12. The method of claim 8, wherein the DHCP component comprises a DHCP service that identifies the IP data by generating and storing the IP data for the wireless network connection.

13. The method of claim 12, wherein the DHCP relay identifies the IP data by retrieving the IP data for the wireless network connection from an external DHCP service external to the wireless communications VM of the edge device.

14. The method of claim 13, wherein the edge device comprises at least one of a gateway device and a router device.

15. A non-transitory computer readable medium embodying instructions executable in at least one computing device that, wherein the instructions, when executed by the at least one computing device, cause the at least one computing device to at least:
launch, by an edge hypervisor of an edge device, a wireless communications virtual machine (VM) comprising a guest operating system (OS) that provides drivers for a wireless adapter of the edge device, wherein the wireless communications VM comprises the lowest or first operational VM identifier of a set of operational VMs executed by the edge device;
configure, by the wireless communications VM, network connection data that enables a wireless adapter to connect to a wireless network;
execute, within the wireless communications VM, a Dynamic Host Configuration Protocol (DHCP) component; and
enable a wireless network connection using the edge hypervisor and the wireless communications VM, wherein the DHCP component of the wireless communications VM assigns or relays Internet Protocol (IP) data for the wireless network connection.

16. The non-transitory computer readable medium of claim 15, wherein the edge device passes control of a device controller for the wireless adapter to the wireless communications VM.

17. The non-transitory computer readable medium of claim 15, wherein the instructions, when executed by the at least one computing device, cause the at least one computing device to at least:
create a virtual networking interface card (NIC) for a respective one of a plurality of wireless adapters of the edge device, wherein the edge device comprises a physical NIC.

18. The non-transitory computer readable medium of claim 15, wherein the instructions, when executed by the at least one computing device, cause the at least one computing device to at least:
identify that the guest OS lacks the drivers for the wireless adapter;
retrieve, from a network location, the drivers for the wireless adapter; and
install, to the guest OS, the drivers for the wireless adapter.

19. The non-transitory computer readable medium of claim 15, wherein the DHCP component comprises a DHCP service that identifies the IP data by generating and storing the IP data for the wireless network connection.

20. The non-transitory computer readable medium of claim 15, wherein the DHCP relay identifies the IP data by retrieving the IP data for the wireless network connection from an external DHCP service external to the wireless communications VM of the edge device.
